(19) United States
(12) Patent Application Publication
(10) Pub. No.: US 2018/0313485 A1
(43) Pub. Date: Nov. 1, 2018

(54) AIR HOSE CONNECTION DEVICE

(71) Applicant: Paul Lightfoot, Willis, TX (US)

(72) Inventor: Paul Lightfoot, Willis, TX (US)

(21) Appl. No.: 15/497,464

(22) Filed: Apr. 26, 2017

(51) Int. Cl. F16L 33/30; F16L 33/34

(52) U.S. Cl. CPC F16L 33/30; F16L 33/34

(57) ABSTRACT

An air hose connection device is characterized by a hollow cylinder having a raised concentric ring at its midpoint, the two halves of the cylinder being roughly identical. The hollow cylinder also has a series of concentric smaller rings, each of which consists of a proximal portion, a distal portion, and a groove located approximately in the concentric smaller ring's center. In some embodiments, the proximal portion is configured to make contact with an air hose's interior, leaving a gap between the air hose's interior and the distal portion and the groove. In some embodiments, this gap may be filled with weld-fast or other such glue. Once each side of the present invention has been secured into two air hose ends, and a sufficient connection has been made between the proximal portions of the present invention and the air hose pieces' interiors, a secure airtight portal may be created between the two air hose pieces, allowing the air hoses to function as a contiguous air hose line.

### CROSS-REFERENCE TO RELATED APPLICATION

Not applicable.

### TECHNICAL FIELD

The disclosed subject matter relates generally to hose replacement kits and, more particularly, to an air hose connection device.

### BACKGROUND

Air compressors are commonly used for transmitting power to rock drills, jackhammers, air motors, pumps, and many more types of construction equipment. Air compressors and the tools they power enable workers to bore holes, cut materials, crush rock, pour vibrated concrete, and perform countless other construction applications.

Unfortunately, there are many objects on a construction job site which can damage the hoses on the air compressors. When an air hose has been punctured or springs a leak, often times a brass hose barb and external hose clamps are used to repair the hose. However, the hose is never quite the same as the clamps tend to get hung up on surrounding objects when the hose is moved. In such situations, workers must constantly slow down or retrace their steps to release a wedged air hose when the hose is hung up. Many workers find such tasks annoying.

Most frustratingly, many such circumstances result in a severed air hose. When this occurs, workers must often replace the hose, usually at a significant cost to the company and at a great expense of time and energy. This creates a problem on many job sites: how to splice together two parts of an air hose.

Many attempts to advance the art of air hose repair have been made. One such attempt can be seen with respect to U.S. Pat. No. 6,086,118, incorporated in its entirety by reference herein. While this disclosure does generally provide for a quick-connect air hose adapter, this disclosure fails to disclose a single connector piece that provides for an identical, bi-directional connection means.

Another attempt can be seen with respect to U.S. Pat. No. 4,949,745, incorporated in its entirety by reference herein, which generally discloses a two-piece connection apparatus. While the connector shown in this disclosure does simplify the connection process, it only provides for a two-piece assembly that does not provide for a single piece capable of uniting two hoses.

Yet another attempt can be seen with respect to U.S. Pat. No. 4,948,180, incorporated in its entirety by reference herein, which generally discloses a hose connection device configured to be attached to a hose on one end, and bore into another hose with the other end. While this disclosure does provide for the ability to connect one air hose with another, it fails to provide for a way to connect two independent air hoses using a device having identical connection sides.

Hence, none of these in existence comprise beneficial characteristics described in the following disclosure. Thus, there remains a need for an air hose connection device that may be inserted into the ends of two hoses.

### SUMMARY OF THE INVENTION

The present invention relates to an air hose connection device. It is contemplated that the present invention may provide an easy and secure way to connect two air hoses on a job site.

For purposes of summarizing, certain aspects, advantages, and novel features of the present invention are provided herein. It is to be understood that not all such aspects, advantages, or novel features may be provided in any one particular embodiment. Thus, the disclosed subject matter may be embodied or carried out in a manner that achieves or optimizes one aspect, advantage, or novel feature or group of features without achieving all aspects, advantages, or novel features as may be taught or suggested.

In one embodiment, the present invention may provide for a hollow brass hose barb that slips inside two air hoses, thereby repairing them and splicing them together. In some embodiments, once the present invention has been installed internally, the two hoses will be held together without leaking and will be able to withstand the pressure from the compressor without blowing apart.

In some embodiments, the present invention provides for sharp steps on this brass hose barb that may grab against the interior of an air hose line as the present invention is pushed inside the open ends of two separate pieces of the air hose. The present invention may also provide for grooves that may be cut into the surface of the present invention and that may hold one or more portions of, by way of illustration and not limitation, weld-fast glue. As the present invention slides inside the hose and the present invention's barb makes contact with the interior of the hose, the present invention may provide that the glue is spread evenly between the outside of the present invention, including the present invention's barb, and the inside of the hose creating an airtight, secure internal connection between the two pieces. In preferred embodiments, the present invention may also be hollow on the inside, thereby allowing air to flow unobstructed through the full length of each hose when a compressor is turned on.

### BRIEF DESCRIPTION OF THE DRAWINGS

These and other features, aspects and advantages of the present invention will become better understood with regard to the following description, appended claims, and accompanying figures where:

FIG. 1 shows a perspective view of an air hose connection device in accordance with one embodiment of the invention.

FIG. 2 shows an elevational view of an air hose connection device in accordance with one embodiment of the invention.

FIG. 3 shows an elevational view of an air hose connection device in use in accordance with one embodiment of the invention.

### DETAILED DESCRIPTION

The present invention overcomes the limitations of the prior art by providing a new and more effective air hose connection device.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any embodiment or element of an embodiment disclosed in this disclosure will be determined by its intended use.

It is to be understood that the drawings and the associated descriptions are provided to illustrate potential embodiments of the invention and not to limit the scope of the invention. Reference in the specification to “one embodiment” or “an embodiment” is intended to indicate that a particular feature, structure, or characteristic described in connection with the embodiment is included in at least an embodiment of the invention. The appearances of the phrase “in one embodiment” or “an embodiment” in various places in the specification are not necessarily all referring to the same embodiment.

Throughout the drawings, reference numbers are re-used to indicate correspondence between referenced elements. In addition, the first digit of each reference number indicates the figure where the element first appears.

As used in this disclosure, except where the context requires otherwise, the term “comprise” and variations of the term, such as “comprising”, “comprises” and “comprised” are not intended to exclude other additives, components, integers or steps.

In the following description, specific details are given to provide a thorough understanding of the embodiments. However, it will be understood by one of ordinary skill in the art that the embodiments may be practiced without these specific detail. Well known features, elements or techniques may not be shown in detail in order not to obscure the embodiments.

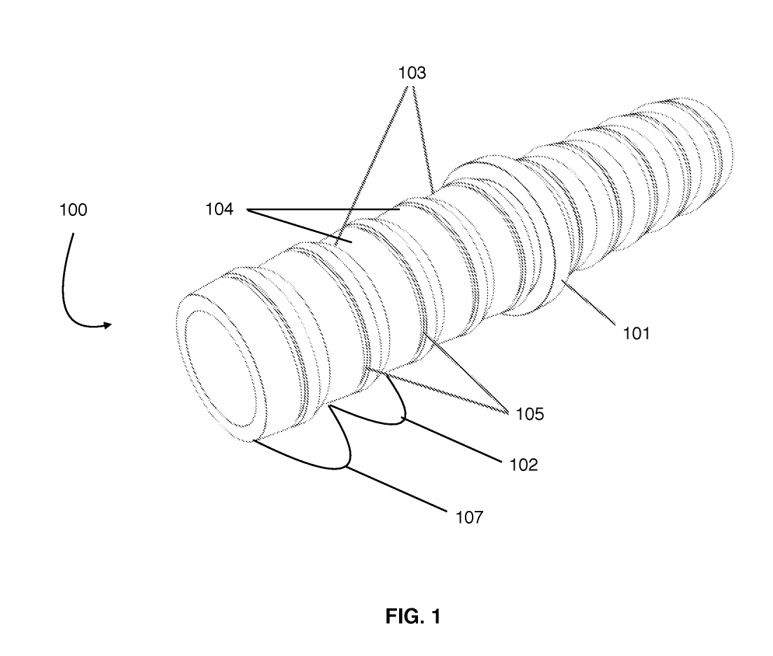

Turning attention to FIG. 1, a perspective view of an air hose connection device in accordance with one embodiment of the invention is shown. In the embodiment depicted, the present invention comprises a cylinder 100 that may be substantially hollow in its interior, and that provides for two sides that are mirror images of each other. The present invention may also provide for a raised concentric center ring 101 that extends laterally and runs radially around the exterior of cylinder 100. The present invention may also provide for a series of small raised concentric rings 102 that also extend laterally and run radially around the exterior of cylinder 100. Each raised concentric ring 102 may me composed of three portions, a proximal portion 103, a distal portion 104, and an interior groove 105. Proximal and distal are used herein in reference to concentric center ring 101. In certain embodiments, the edge of each proximal portion 103 and each distal portion 104 may provide for a sharp surface angle 106 that enables the present invention to better adhere to the interior wall of an air hose. Some embodiments of the present invention may also provide that grooves 105 may be filled with weld-fast glue or otherwise provide for one or more glues to be added to the present invention, thereby enhancing its adherence to an air hose's interior. FIG. 1 also discloses that, in some embodiments, terminal raised concentric rings 107 may be relatively larger than raised concentric rings 102. In some embodiments, it is contemplated that this size difference may provide for additional adherence to an air hose's interior surface.

Continuing with FIG. 1, it is contemplated that in certain embodiments, the present invention may not be symmetrical. It is contemplated that in some embodiments, one side of the present invention, as measured from the raised concentric center ring 101 to the terminal raised concentric rings 107, may provide for a larger or smaller diameter of cylinder 100 than the other side of cylinder 100.

Additionally, continuing with FIG. 1, it is contemplated that in certain embodiments, distal portion 104 rather than proximal portion 103 may make contact with the interior surface of an air hose. In some embodiments, both proximal portion 103 and distal portion 104 may make contact with the interior surface of an air hose. In some embodiments, neither proximal portion 103 nor distal portion 104 may make contact with the interior surface of an air hose.

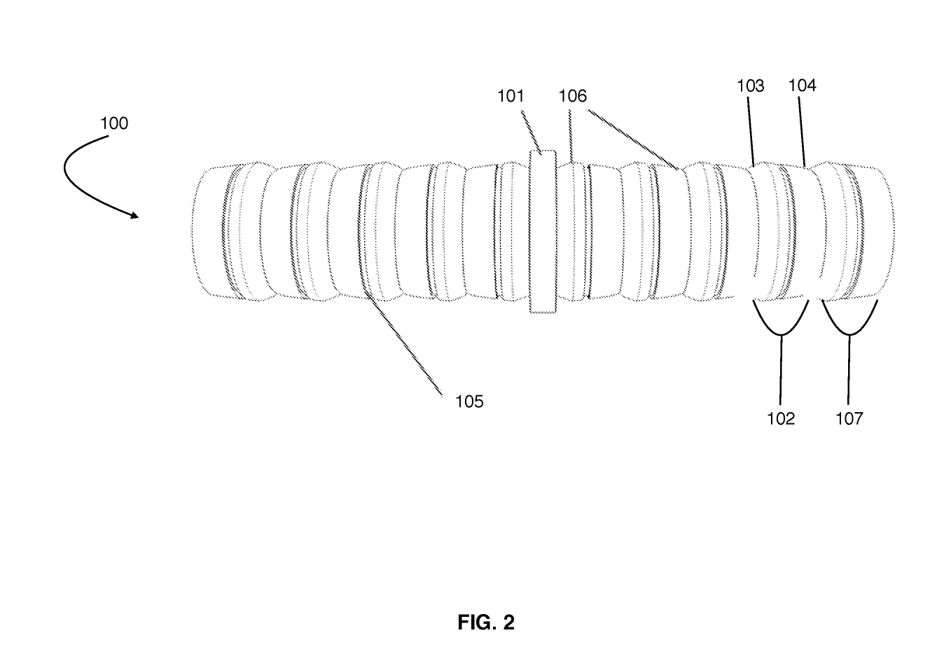

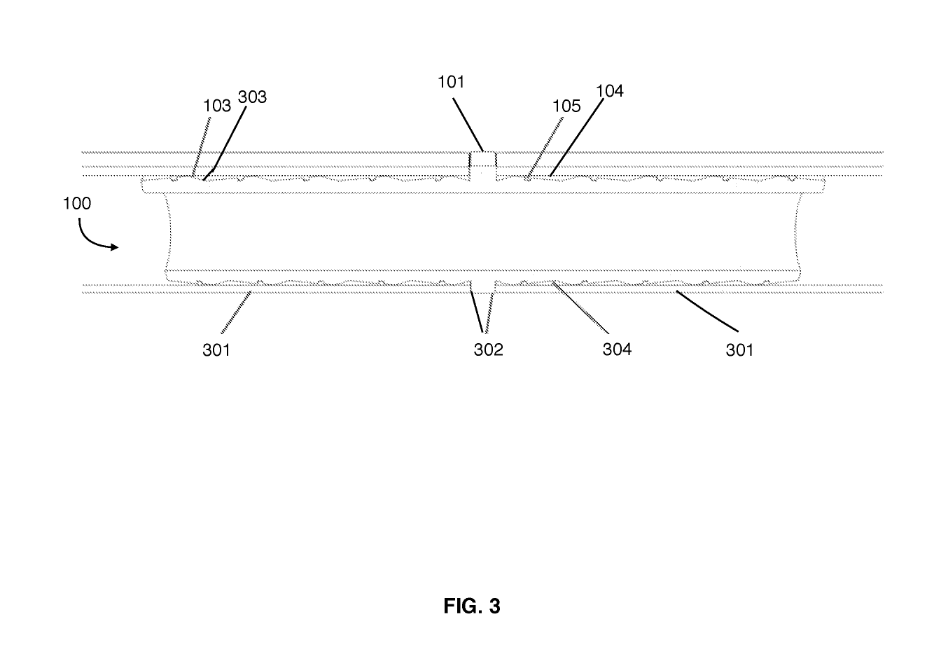

Remaining with FIG. 1, it is further contemplated that in some embodiments sharp surface angle 106 may be of any possible angle in addition to or as an alternative to the angle shown in FIG. 1, as well as FIGS. 2 and 3. Furthermore, in some embodiments sharp surface angle 106 may be part of only distal portion 104. In some embodiments sharp surface angle 106 may be part of only proximal portion 103. In some embodiments, both proximal portion 103 and distal portion 104 may provide for sharp surface angle 106. It is further contemplated that in some embodiments, neither proximal portion 103 nor distal portion 104 may provide for sharp surface angle 106.

Continuing with FIG. 1, in some embodiments grooves 105 may be of alternate depths than the depth generally disclosed in FIG. 1, as well as FIGS. 2 and 3. In addition, grooves 105 may be wider or narrower than the width generally disclosed in FIG. 1, as well as FIGS. 2 and 3. In still other embodiments, grooves 105 may be absent.

With respect to FIG. 2, in the illustrative embodiment depicted, which is provided for purposes of illustration and not limitation, additional visual clarity concerning an embodiment of the present invention is provided. In the embodiment shown, the viewer can better understand the relative size relationships between the cylinder 100, the raised concentric center ring 101, the small raised concentric rings 102, proximal portions 103 including surface angles 106, distal portions 104, interior grooves 105, and terminal raised concentric rings 107. The reader's attention is also drawn to the relative depth of grooves 105 and the relative placement of glue that grooves 105 may accommodate. It is also contemplated that in certain embodiments, while the proportions may remain the same, the overall present invention may be larger or smaller in some embodiments to accommodate air hoses of larger or smaller diameters.

FIG. 3 shows an illustrative elevational view of an air hose connection device in use in accordance with one embodiment of the invention. In the embodiment depicted, two air hose ends 301 terminate at either side of the flat edges 302 of raised concentric center ring 101. FIG. 3 also discloses that proximal portion 103 is configured to make contact with air hose interior surface 303, leaving an open glue pocket 304 area between distal portion 104, interior groove 105, and air hose interior surface 303.

### CONCLUSIONS, RAMIFICATIONS, AND SCOPE

Although the present invention has been described with a degree of particularity, it is understood that the present disclosure has been made by way of example and that other versions are possible. As various changes could be made in the above description without departing from the scope of the invention, it is intended that all matter contained in the above description or shown in the accompanying drawings shall be illustrative and not used in a limiting sense. The spirit and scope of the appended claims should not be limited to the description of the preferred versions contained in this disclosure.

All features disclosed in the specification, including the claims, abstracts, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function should not be interpreted as a “means” or “step” clause as specified in 35 U.S.C. § 112.

While the garment and method of using the same has been disclosed in connection with a number of embodiments shown and described in detail, various modifications should be readily apparent to those of skill in the art.

What is claimed is:

1. An air hose connection device, comprising:
a hollow cylinder with an interior, an exterior, a first end, a second end, and a midpoint;
a central raised ring portion on the exterior of the cylinder and located at the midpoint of the cylinder;
a plurality of concentric raised ring portions on the exterior of the cylinder, each concentric raised ring portions comprising:
a) a proximal portion;
b) a distal portion; and
c) a groove located between the proximal portion and the distal portion.

2. The device of claim 1, wherein the proximal portion is configured to make contact with an interior surface of an air hose.

3. The device of claim 2, wherein the proximal portion is configured to provide for a sharp surface angle, the sharp surface angle being diagonal relative to the plane of the central raised ring portion.

4. The device of claim 3, further comprising a terminal concentric raised ring element located at the cylinder's first end, wherein the terminal concentric raised ring element has a larger diameter than the concentric raised ring elements, the terminal concentric raised ring element comprising:
a) a proximal portion;
b) a distal portion; and
c) a groove located between the proximal portion and the distal portion.

5. The device of claim 4, wherein a terminal concentric raised ring element is located at both the cylinder's first end and at the cylinder's second end.
